(19) United States
(12) Patent Application Publication
(10) Pub. No.: US 2003/0112415 A1
(43) Pub. Date: Jun. 19, 2003

(54) Apparatus for projection and capture of a display interface

(75) Inventors: Hsiu-O Hsu, Hsin-Chu (TW); Jen-Shou Tseng, Miao-Li (TW)

Correspondence Address: LOWE HAUPTMAN GILMAN & BERNER, LLP, 1700 Diagonal Road, Suite 310, Alexandria, VA, 22314, US

(73) Assignee: UMAX DATA SYSTEMS INC.

(21) Appl. No.: 10/020,438

(22) Filed: Dec. 18, 2001

(51) Int. Cl. G03B 21/00

(52) U.S. Cl. 353/42

(57) ABSTRACT

Apparatus for projecting a display interface on a remote screen comprises a means such as scanning device for capturing the display interface comprising a visual pointer appearing on the remote screen. The visual pointer is positioned to reference a subject portion of the display interface and produced by a pointer device. The apparatus comprises another a means such as a projector for projecting display content on the remote screen according to the capturing means. The display content is corresponding to the subject portion of the display interface and directly displayed after the scanning of capturing means.

### BACKGROUND OF THE INVENTION

1. Field of the Invention

The invention relates to a display apparatus, and more particularly relates to an image projection apparatus with capture of the image.

2. Description of the Prior Art

Display systems for projecting images onto screens and other suitable surfaces for viewing by large audiences are known. Devices used to project images onto screens include document cameras, overhead projectors, slide projectors, and video cameras. The projected images can be generated by computer programs or by light passing through film slides.

Such project systems are typically used for demonstrating and training purposes, as well as for electronic slide shows. In the demonstration or training application, the projected image represents a “live” computer screen, and the operation of the computer or a software application program can be demonstrated to a group of people simultaneously. In this regard, the user of the equipment operates a computer, such as a conventional personal computer, in a conventional manner and whatever appears on the computer monitor screen, is duplicated on the large screen for all to see. In such an application, the user or presenter interacts with the computer, and must be positioned at the computer console to demonstrate the application program being executed by the computer.

Therefore, it would be highly desirable to be able to modify or to highlight the presentation information, without the need of the presenter going to the computer console to enter information for making necessary adjustments. It also would be highly desirable for a user to be able to highlight or accent selected portions of the screen, during the presentation, without using the computer keyboard, and without even going near the images being presented should be able to be projected, during any frame of the screen images being projected at the control of the presenter.

### SUMMARY OF THE INVENTION

It is a principal object of the present invention to provide an apparatus for projecting and capturing an image on a remote screen. Users can view subject content included in the image with a pointer device that produces a visual pointer on the remote screen.

It is another object of the present invention to provide an projector apparatus with scanning function. In use of scanning function, a picture contained or linked in a projected image could be directly projected without manually operating a computer.

It is further object of the present invention to provide a projector enabling to execute scanning a projected image. The projected image has a visual mark by a remote pointer device and is scanned by the projector for comparing the projected image with or without the visual mark. Thus, a subject content referenced to the position of the visual mark can be projected by the projector.

In the present invention, apparatus for projecting a display interface on a remote screen comprises a means such as scanning device for capturing the display interface comprising a visual pointer appearing on the remote screen. The visual pointer is positioned to reference a subject portion of the display interface and produced by a pointer device. The apparatus comprises another a means such as a projector for projecting display content on the remote screen according to the capturing means. The display content is corresponding to the subject portion of the display interface and directly displayed after the scanning of capturing means.

### BRIEF DESCRIPTION OF THE DRAWINGS

A better understanding of the invention may be derived by reading the following detailed description with reference to the accompanying drawings wherein:

FIG. 1 is a schematic view of an image display system connected to a computer in accordance with the present invention;

FIG. 2 is a block diagram illustrating the display system of FIG. 1 in accordance with the present invention; and

FIG. 3 is a flow chart in accordance with the present invention.

### DESCRIPTION OF THE PREFERRED EMBODIMENT

While the invention is described in terms of a single preferred embodiment, those skilled in the art will recognize that many devices described below can be altered as well as other substitutions with same function and can be freely made without departing from the spirit and scope of the invention.

Furthermore, there is shown a representative portion of display apparatus or project apparatus of the present invention in enlarged. The drawings are not necessarily to scale for clarify of illustration and should not be interpreted in a limiting sense. Furthermore, the present invention can be applied on other project systems.

In the present invention, apparatus for projecting a subject content of a display interface on a remote screen comprises a capturing device for scanning the display interface comprising a visual pointer appearing on the remote screen. The visual pointer is positioned to reference a portion of the display interface and the portion represents the subject content. A projector is for projecting the display interface and projecting the subject content, wherein the display interface is projected prior to the subject content. A means is used for processing and comparing the display interface scanned by the capturing device and the display interface projected by the projector.

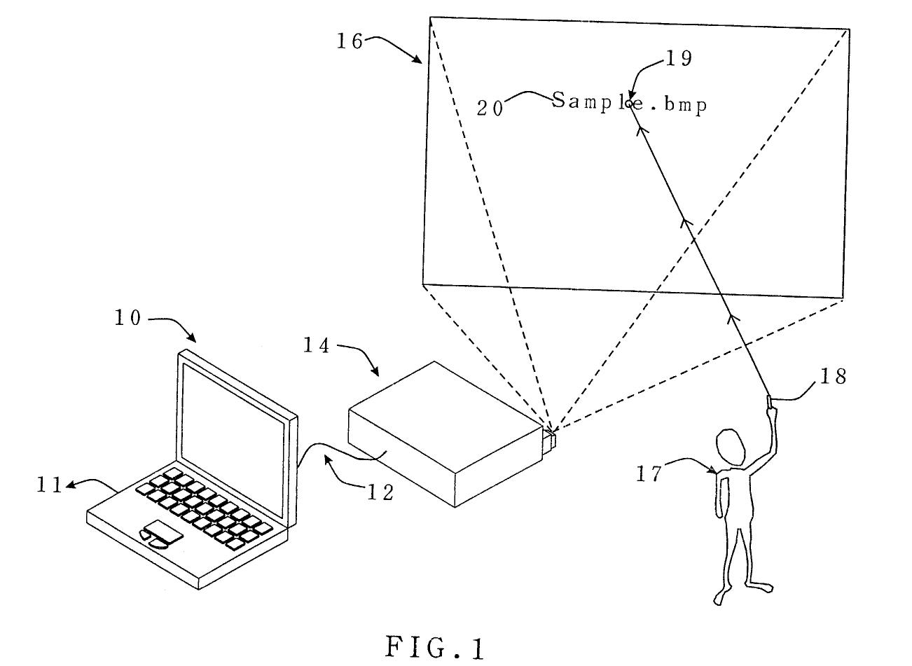

FIG. 1 is a schematic view of an image display system connected to a computer in accordance with the present invention. A computer 10, such as a notebook, is connected to a display system 14 through at least a communication line 12. In an embodiment, the computer 10 could be connected to Internet through a network 11. Furthermore, the display system 14 is project system with scan function in the embodiment, which outputs displayed interface from the computer 10 on a screen to generate a projected image 16. The displayed interface would be included an object that represents an image as any type, such a linked filename 20 saved in the local computer 10, or the hyper-linked address of a website. When the remote (away from computer 10) user 17 directs an intense light beam with a laser pointer 18 or a light pen at the projected image 16, the light beam impinges on the screen creating a visual point 19. In the embodiment, the visual point 19 is located on a position that represents the object or the hyper-linked address of the website. Thus, the display system 14 of the present invention would response to the visual point 19 on the projected image 16 to output the corresponding image or display indicated by the visual point 19.

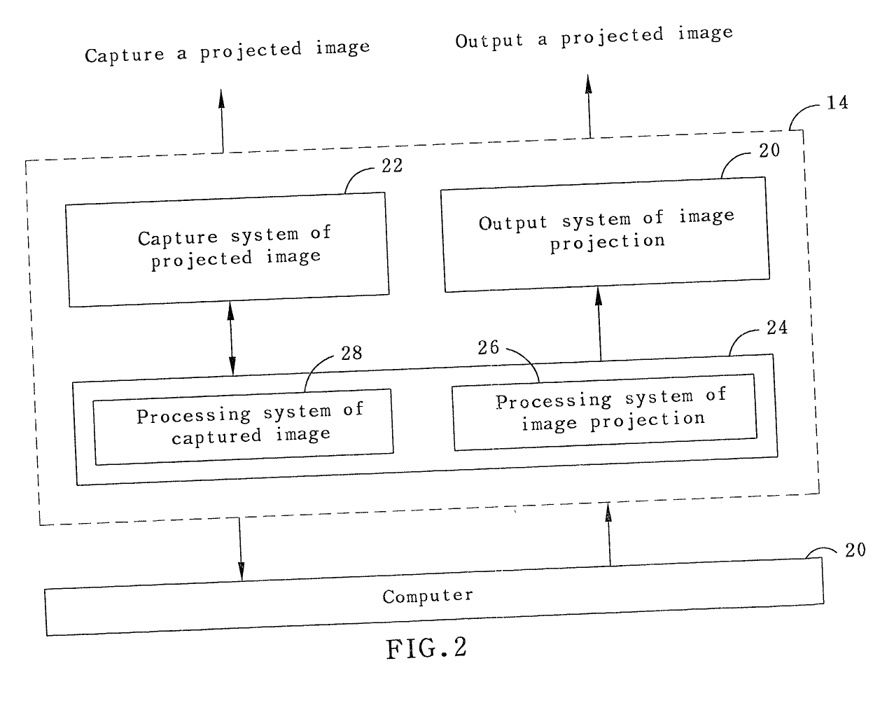

FIG. 2 is a block diagram illustrating the display system of FIG. 1 in accordance with the present invention. The display system 14 comprises a main control system 24, such as a microprocessor and related peripheral circuit and controlling devices; an output system of image projection 20, such as multitudes of image-projecting devices; and a capture system of projected image 22, such as multitudes of image-capturing devices. The main control system 24 comprises a process system of image projection 26 and a processing system of captured image 28. The displayed interface is transferred from the computer 10 to the display system 14 and the processing system of image projection 26 is responsible for the data processing of the displayed interface. Next, the output system of image projection 20 is responsible for the projection settings and then output the projected image of the displayed interface.

When the remote user directs the visual point with the laser pointer on the position of the projected image, the capture system of projected image 22 is simultaneously driven to capture the whole projected image that the visual point is existed thereon. The projected image including the visual point is captured (or scanned) by the captured system of projected image and then transferred into the processing system of captured image 28 for comparing with the displayed interface. When a corresponded linked object is indicated by comparing the position of the visual point on the displayed interface, a request for the corresponded linked object is set by the display system 14 to the computer 10. The computer 10 outputs the corresponded linked object according to the request and then the corresponded linked object is projected on the screen.

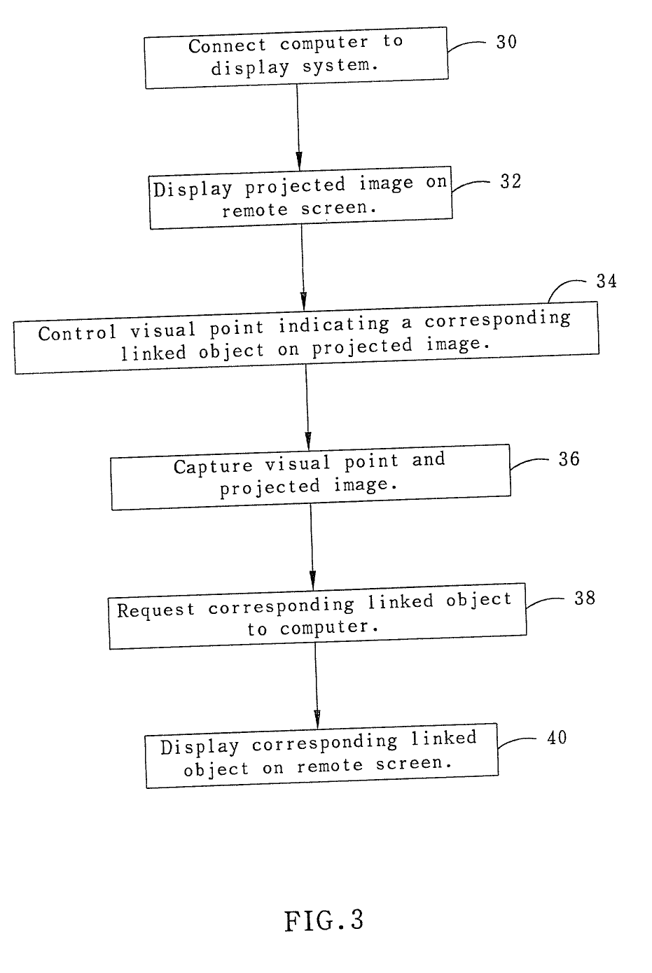

FIG. 3 is a flow chart in accordance with the present invention. Users connect a computer to the display system of the present invention (step 30). Users use the computer to output any displayed interface to the display system. The display system outputs the projected image corresponding to the displayed interface on a remote screen (step 32). When users would like to look at partial content of the displayed interface in detail, such as a linked picture, they would direct a laser pointer or a light pen to the position corresponding to the linked picture on the projected image. Thus, the position corresponding to the linked picture is indicated with a visual point emitted from the laser pointer (step 34). At the same time, the display system would be triggered by the laser point and execute the scanning of the projected image thereon comprising the visual point (step 36).

Next, A capture system of projected image in the display system is responsible to capture the projected image and transfers the image data of the projected image to a processing system of capture image in the display system. Coordinated with a processing system of image projection in the display system, the processing system of capture image distinguishes the position of the visual point and requests the corresponding linked object to the computer (step 38). The computer accepts the request of the corresponding linked object and then outputs the displayed content of the corresponding linked object to the display system. Next, the display system outputs the displayed content of the corresponding linked object on the remote screen (step 40).

One objective of the present invention provides the automatic display of a selected object on the remote screen. Users need not to manually request the computer. The display system would automatically request the computer according to the detection of the visual point on the remote screen. The selected object could be stored as a file in the computer, or any remote storage device connected to the computer. The selected object on the projected image could be displayed as a filename, a represent icon, or a web-site address.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. Apparatus for projecting and capturing a display interface on a remote screen, said apparatus comprising:
means for capturing said display interface comprising a visual pointer appearing on said remote screen, said visual pointer being positioned to reference a subject portion of said display interface; and
means for projecting a display content on said remote screen according to said capturing means, said display content being corresponding to said subject portion of said display interface.

2. The apparatus of claim 1, wherein said capturing means is triggered by means for producing said visual pointer.

3. The apparatus of claim 2, wherein said producing means is a laser pointer.

4. The apparatus of claim 2, wherein said producing means is a light pen.

5. The apparatus of claim 1, wherein said display interface is derived from a computer connected to said apparatus.

6. The apparatus of claim 5, wherein said display content is stored in said computer.

7. The apparatus of claim 5, wherein said display content is stored in a server communicated with said computer.

8. Apparatus for projecting a subject content of a display interface on a remote screen, said apparatus comprising:
a capturing device for scanning said display interface comprising a visual pointer appearing on said remote screen, said visual pointer being positioned to reference a portion of said display interface, said portion representing said subject content;
a projector for projecting said display interface and projecting said subject content, said display interface being projected prior to said subject content; and
means for processing and comparing said display interface scanned by said capturing device and said display interface projected by said projector.

9. The apparatus of claim 8, wherein said capturing device is triggered by a laser pointer that produces said visual pointer.

10. The apparatus of claim 8, wherein said capturing device is triggered by a light pen that produces said visual pointer.

11. The apparatus of claim 8, wherein said subject content is stored in a storage device connected to said apparatus.

12. The apparatus of claim 8, wherein said subject content is stored in a remote storage device communicated with said apparatus.

13. A projector with scanning function, said projector comprising:
a capturing system for scanning a display interface comprising a visual pointer appearing on a remote screen, said visual pointer being positioned to reference a portion of said display interface, said portion representing said subject content;
a projecting device for projecting said display interface and projecting said subject content, said display interface being projected prior to said subject content; and
a processing system for processing and comparing said display interface scanned by said capturing system and said display interface projected by said projecting system.

14. The projector of claim 13, wherein said capturing system comprises a plurality of image-capturing devices.

15. The projector of claim 13, wherein said capturing system is triggered by a laser pointer that produces said visual pointer.

16. The projector of claim 13, wherein said capturing system is triggered by a light pen that produces said visual pointer.

17. The projector of claim 13, wherein said subject content is stored in a computer connected to said projector.

18. The projector of claim 13, wherein said subject content is stored in a remote storage device communicated with said projector.
